(19) United States
(12) Patent Application Publication
(10) Pub. No.: US 2011/0253054 A1
(43) Pub. Date: Oct. 20, 2011

(54) STABILIZED PET DISH ASSEMBLY AND METHOD

(76) Inventor: Drake Hargrove, Havelock, NC (US)

(21) Appl. No.: 12/903,747

(22) Filed: Oct. 13, 2010

Related U.S. Application Data
(63) Continuation-in-part of application No. 12/583,641, filed on Aug. 24, 2009.

(51) Int. Cl. A01K 5/00; B65D 90/00

(52) U.S. Cl. 119/61.54; 206/459.5

(57) ABSTRACT

A vessel assembly for holding and presenting solids, liquids or both, including a vessel body having a base portion and at least one wall member extending from the base portion and defining at least one cavity for containing solids, liquids or both; a stabilizer including a stabilizer body for ground engagement; and a fastener assembly for releasably retaining the body and the stabilizer in a mated relationship, the fastener including a first fastener portion operatively associated with the vessel body and a second fastener portion operatively associated with the stabilizer in a configuration for mating with the first fastener portion for stabilizing the vessel.

### CROSS-REFERENCE TO RELATED APPLICATION

This is a Continuation-In-Part of U.S. patent application Ser. No. 12/583,641, filed Aug. 24, 2009.

### BACKGROUND OF THE INVENTION

The present invention relates broadly to apparatus and methods for facilitating feeding and nourishing animals such as pets and, more particularly, to a stabilized pet dish assembly that includes an anti-tip feature for both indoor and outdoor use.

It is generally good practice to provide pet animals such as dogs with a water dish outdoors. Especially desired in hot weather, a dog's need for water can be satisfied without bringing the dog inside. Further, some dogs actually live outdoors, some in fenced enclosures containing a conventional dog house. With or without an enclosure, the need to keep a water dish, food dish or both near a dog's habitat is important for the wellbeing of the animal, both indoors and outdoors.

One of the problems with leaving conventional dog or pet dishes adjacent a dog's habitat is that the dog or other animal can easily upend the dish, thereby spilling its contents. If the contents are dry food, the spillage would make little difference to the dog who would merely eat the dry food from the ground. On the other hand, if the spillage involves water, the water is irretrievable as it would likely soak into the ground. If the spillage occurs indoors, it must be cleaned up to maintain an orderly dog feeding area.

For use outdoors, attempts have been made in the past to apply multiple spikes to the bottom of a dog dish so that the spikes can be driven into the ground to prevent upending of the dish. Examples of such structure are disclosed in U.S. Pat. No. 3,202,181 to Jones and US Patent Publication No. 2007/0266952 to Cruse. Among disadvantages of this type of structure is the possible difficulty in removing the dish from the ground for refilling, grooming the area around the dish or for dish cleaning. Further, driving the dish into the ground with the dish full of water could be a difficult task and would likely result in spillage of the water or the contents of the dish.

Accordingly, there exists a need for a pet water dish for use indoors and outdoors that can be anchored to the ground or other support structure in an easy and efficient manner and can also be removed in a likewise easy and efficient manner.

### SUMMARY OF THE INVENTION

It is accordingly an object of the present invention to provide a pet dish for indoor and outdoor use which may be selectively anchored to the ground or other support structure.

It is another object of the present invention to provide such a pet dish wherein the pet dish may be readily attached or detached from a support as necessary.

It is another object of the present invention to provide a method for stabilizing a pet dish on a support surface wherein the pet dish may be readily attached or detached from a support as necessary.

To those ends, the present invention is directed to a vessel assembly for holding and presenting solids, liquids or both. The vessel assembly includes a vessel body having a base portion and at least one wall member extending from the base portion and defining at least one cavity for containing solids, liquids or both. A stabilizer element includes a stabilizer body for engagement with an underlying surface. The present invention further includes a fastener assembly for releasably retaining the body and the stabilizer in a mated relationship, the fastener assembly including a first fastener portion operatively associated with the vessel body and a second fastener portion operatively associated with the stabilizer in a configuration for mating with the first fastener portion when the second fastener portion is closely adjacent a support surface.

Preferably, the stabilizer body is formed as a generally planar mat having the fastener assembly disposed thereonto. It is further preferred that the mat extends in a generally horizontal manner outwardly from the vessel body. Preferably, the mat is configured for displaying indicia thereon.

It is preferred that the first fastener portion is formed with at least one wall defining a receiving chamber and a cover for covering the receiving chamber. The cover is formed with a keyway therein, and the second fastener body portion includes at least one boss projecting therefrom and configured for selective engagement with the keyway formed in the cover of the first fastener portion for selective retention of the vessel and the stabilizer in a mated relationship.

Preferably, at least one of the first fastener portion and the second fastener portion includes a receiving chamber formed therein and the second fastener portion includes a body portion configured for receipt in the receiving chamber. The receiving chamber is configured for selective retention of the body portion in a mated relationship therewith. It is preferred that at least one of the first fastener portion and the second fastener portion is formed with at least one wall defining the receiving chamber, with the at least one wall being formed with at least one slot therein and the other of the first fastener portion and the second fastener portion includes at least one boss projecting therefrom and configured for selective engagement with the at least one slot for selective retention of the vessel and the stabilizer in a mated relationship.

It is further preferred that the first fastener portion and the second faster portion are configured for engagement with one another by relative rotational motion of the first fastener portion and the second fastener portion between a first position wherein the first fastener portion is engaged with the second fastener portion and a second position wherein the first fastener portion and the second fastener portion are retained in a mated relationship, thereby retaining the vessel and the stabilizer in a mated relationship.

It is preferred that the first fastener portion and the second faster portion are configured for relative rotational motion of about ¼ of a full 360 degree rotation to about ½ of a full 360 degree rotation of the vessel with respect to the stabilizer and thereby the first fastener portion with respect to the second fastener portion that results in the first fastener portion and the second fastener portion experiencing relative movement between a first position wherein the first fastener portion is engaged with the second fastener portion and a second position wherein the first fastener portion and the second fastener portion are retained in a mated relationship, thereby retaining the vessel and the stabilizer in a mated relationship.

According to another preferred embodiment of the present invention, at least one of the first fastener portion and the second fastener portion includes at least one wall forming a receiving chamber therein. The at least one wall is threaded. The other of the first fastener portion and the second fastener portion includes a fastener body being formed with threads operationally corresponding to the threads formed on the receiving chamber, with the receiving chamber being configured for selective retention of the fastener body in a threadedly mated relationship therewith.

According to another preferred embodiment of the present invention, at least one of the first fastener portion and the second fastener portion includes a receiving portion formed thereon and the other of the first fastener portion and the second fastener portion includes a corresponding member configured for receipt by the receiving portion. At least one magnet is disposed on at least one of the receiving portion and the corresponding member, and wherein at least one of the receiving portion and the corresponding member includes a magnetically attractive element for selective retention of the receiving portion in a magnetically mated relationship with the corresponding member.

In other terms and according to another preferred embodiment of the present invention, a pet dish is provided for holding and presenting pet-related items, the pet dish being generally for outdoor disposition. The pet dish assembly for holding and presenting pet-related items includes a dish body having a base portion and at least one wall member extending from the base portion and defining at least one cavity for containing pet related items. A support member includes a generally elongate body for engagement with an underlying surface. Further provided is a fastener assembly for releasably retaining the dish and the support member in a mated relationship, the fastener including a first fastener portion operatively associated with the dish and a second fastener portion operatively associated with the support member in a configuration for mating with the first fastener portion for impeding relative movement of the dish body and the support member when the pet dish assembly is in use.

Preferably, the support member includes a generally planar horizontally extending mat for generally parallel engagement with a support surface. It is preferred that the mat is configured for displaying indicia thereon.

Alternately, it is preferred that the support member includes a generally elongate body for penetrating ground engagement

Preferably, the fastener assembly is provided for releasably retaining the dish and the support member in a mated relationship, with the fastener including a first fastener portion operatively associated with the dish and a second fastener portion operatively associated with the support member in a configuration for mating with the first fastener portion when the second fastener portion is closely adjacent a ground surface with the support member extending into the ground.

It is preferred that at least one of the first fastener portion and the second fastener portion is formed with at least one wall defining a receiving chamber and a cover for covering the receiving chamber. The cover is formed with a keyway therein, and the other of the first fastener portion and the second fastener portion includes at least one boss projecting therefrom and configured for selective engagement with the keyway formed in the cover of the first fastener portion for selective retention of the vessel and the stabilizer in a mated relationship.

Preferably, at least one of the first fastener portion and the second fastener portion includes a receiving chamber formed therein and the other of the first fastener portion and the second fastener portion includes a body portion configured for receipt in the receiving chamber, with the receiving chamber configured for selective retention of the body portion in a mated relationship therewith. It is preferred that at least one of the first fastener portion and the second fastener portion is formed with at least one wall defining the receiving chamber, with the at least one wall being formed with at least one slot therein and the other of the first fastener portion and the second fastener body portion includes at least one boss projecting therefrom and configured for selective engagement with the at least one slot formed for selective retention of the vessel and the stabilizer in a mated relationship.

It is further preferred that the first fastener portion and the second faster portion are configured for engagement with one another by relative rotational motion of the first fastener portion and the second fastener portion between a first position wherein the first fastener portion is engaged with the second fastener portion and a second position wherein the first fastener portion and the second fastener portion are retained in a mated relationship, wherein the vessel and the stabilizer are retained in a mated relationship.

Preferably, the first fastener portion and the second faster portion are configured for relative rotational motion of about ¼ of a full 360 degree rotation to about ½ of a full 360 degree rotation between the vessel and the stabilizer and thereby the first fastener portion and the second fastener portion that results in the first fastener portion and the second fastener portion experiencing relative movement between a first position wherein the first fastener portion is engaged with the second fastener portion and a second position wherein the first fastener portion and the second fastener portion are retained in a mated relationship, thereby retaining the dish and the support member in a mated relationship.

According to another preferred embodiment of the present invention, at least one of the first fastener portion and the second fastener portion includes at least one wall forming a receiving chamber therein, with the at least one wall being threaded. The other of the first fastener portion and the second fastener portion includes a fastener body being formed with threads operationally corresponding to the threads formed on the receiving chamber, with the receiving chamber being configured for selective retention of the fastener body in a threadedly mated relationship therewith.

According to another preferred embodiment of the present invention, at least one of the first fastener portion and the second fastener portion has a receiving portion formed thereon. The other of the first fastener portion and the second fastener portion includes a corresponding member configured for receipt by the receiving portion, with at least one magnet being disposed on at least one of the receiving portion and the corresponding member. At least one of the receiving portion and the corresponding member includes a magnetically attractive element for selective retention of the receiving portion in a magnetically mated relationship with the corresponding member.

According to one preferred embodiment of the method of the present invention, a method is provided for stabilizing a pet dish for holding and presenting pet-related items. The method includes the steps of:
providing a pet dish including a dish body having a base portion and at least one wall member extending from the base portion and defining at least one cavity for containing pet related items;
providing a support member including a generally elongate body for engagement with an underlying surface;
providing a fastener assembly including a first fastener portion operatively associated with the dish and a second fastener portion operatively associated with the support member in a configuration for mating with the first fastener portion;
engaging the support member with the underlying support surface; and
placing the pet dish on the support member in a manner wherein the first fastener portion and the second fastener portion are in a mated relationship.

Preferably, the step of providing a support member includes providing a generally elongate body for engagement with an underlying surface, includes providing a generally planar mat for carrying at least one of the first fastener element and the second fastener element, and the step of engaging the support member with the underlying support surface preferably includes placing the mat on a generally horizontal support surface with the mat extending generally horizontally from the pet dish when in use, wherein a pet can stand on the mat with the dish stabilized thereon to further enhance the stability of the pet dish assembly.

It is further preferred that the step of providing a fastener assembly includes providing a fastener assembly wherein at least one of the first fastener portion and the second fastener portion is formed with at least one wall defining a receiving chamber, with the at least one wall being formed with at least one slot therein and the other of the first fastener portion and the second fastener portion includes at least one boss projecting therefrom and configured for selective engagement with the at least one slot for selective retention of the dish and the support member in a mated relationship.

Preferably, the step of providing a support member includes providing a ground piercing elongate member for ground engagement. The step of engaging the support member with the underlying support surface may preferably include piercing the ground with the support member to a predetermined depth wherein the fastener element is disposed at a predetermined vertical spacing with the ground surface to elevate the pet dish body to a predetermine height above the ground surface. It is further preferred that the step of placing the pet dish on the support member in a manner wherein the first fastener portion and the second fastener portion are in a mated relationship includes engaging the at least one boss projecting from the body portion with the at least one slot formed in the at least one wall of the first fastener portion for selective retention of the dish and the support member in a mated relationship, wherein the pet dish body is disposed at the predetermine height above the ground surface.

Preferably, the step of providing a fastener assembly includes providing a fastener assembly wherein at least one of the first fastener portion and the second fastener portion is formed with at least one wall defining a receiving chamber and a cover for covering the receiving chamber, the cover being formed with a keyway therein, and the other of the first fastener portion and the second fastener body portion includes at least one boss projecting therefrom and configured for selective engagement with the keyway formed in the cover of the first fastener portion for selective retention of the vessel and the stabilizer in a mated relationship and the step of placing the pet dish on the support member in a manner wherein the first fastener portion and the second fastener portion are in a mated relationship includes engaging the at least one boss projecting from the body portion with the keyway formed in the cover of the first fastener portion for selective retention of the dish and the support member in a mated relationship.

It is preferred that the step of providing a fastener assembly includes providing a fastener assembly wherein at least one of the first fastener portion and the second fastener portion is formed with at least one wall defining a receiving chamber, with the at least one wall being formed with at least one slot therein and the other of the first fastener portion and the second fastener portion has at least one boss projecting therefrom and being configured for selective engagement with the at least one slot formed in the at least one wall of the first fastener portion for selective retention of the dish and the support member in a mated relationship. The step of placing the pet dish on the support member in a manner wherein the first fastener portion and the second fastener portion are in a mated relationship includes engaging the at least one boss projecting from the body portion with the at least one slot formed in the at least one wall of the first fastener portion for selective retention of the dish and the support member in a mated relationship.

Preferably, the step of providing a fastener assembly includes providing a fastener assembly wherein the first fastener portion and the second faster portion are configured for relative rotational motion of about ¼ of a full 360 degree rotation to about ½ of a full 360 degree rotation between the first fastener portion and the second fastener portion and thereby between the dish and the support member and thereby. The step of placing the pet dish on the support member in a manner wherein the first fastener portion and the second fastener portion are in a mated relationship includes moving the first fastener portion relative to the second fastener portion about ¼ of a full 360 degree rotation to about ½ of a full 360 degree rotation between a first position wherein the first fastener portion is engaged with the second fastener portion and second position wherein the first fastener portion and the second fastener portion are retained in a mated relationship, thereby retaining the dish and the support member in a mated relationship.

According to another preferred embodiment thereof, the step of providing a fastener assembly includes providing a fastener assembly wherein at least one of the first fastener portion and the second fastener portion includes at least one wall forming a receiving chamber, with the at least one wall being threaded and the other of the first fastener portion and the second fastener portion includes a body being formed with threads operationally corresponding to the threads formed on the receiving chamber. The step of placing the pet dish on the support member in a manner wherein the first fastener portion and the second fastener portion are in a mated relationship includes mating the threads of the first fastener portion with the threads of the second fastener portion and rotating the dish relative to the support member to operationally engage the first fastener portion and the second fastener portion to threadedly retain the dish and the support member in a mated relationship.

According to another preferred embodiment thereof, the present method includes the step of providing a fastener assembly wherein at least one of the first fastener portion and the second fastener portion includes a receiving portion formed thereon and the other of the first fastener portion and the second fastener portion includes a corresponding member configured for receipt by the receiving portion, with at least one magnet being disposed on at least one of the receiving portion and the corresponding member and wherein at least one of the receiving portion and the corresponding member includes a magnetically attractive element. The step of placing the pet dish on the support member in a manner wherein the first fastener portion and the second fastener portion are in a mated relationship includes bringing the first fastener portion into abutment with the second fastener portion for magnetic retention of the first fastener portion with the second fastener portion for selective retention of the pet dish and the support member in a magnetically mated relationship therewith.

### BRIEF DESCRIPTION OF THE DRAWINGS

FIG. 1 is an exploded view of a stabilized pet dish assembly according to two alternate preferred embodiments of the present invention;

FIG. 2 is a perspective view of the fastener assembly according to one preferred embodiment of the present invention;

FIG. 3 is a cutaway view of the stabilized pet dish assembly illustrated in FIG. 1;

FIG. 4 is a side view of the stabilized pet dish assembly illustrated in FIG. 3 shown partially broken open to illustrate a further position of the fastener assembly;

FIG. 5 is s side view of a stabilized pet dish assembly according to another preferred embodiment of the present invention;

FIG. 6 is a side view of the stabilized pet dish assembly illustrated in FIG. 5;

FIG. 7 is an exploded view of a stabilized pet dish assembly according to two alternate preferred embodiments of the present invention;

an operational view of the stabilized pet dish assembly illustrated in FIG. 6 shown partially broken open to illustrate operation of the fastener assembly;

FIG. 8 is a side view of the stabilized pet dish assembly illustrated in FIG. 7 shown in cross section as illustrated in FIG. 3;

FIG. 9 is an operational view of the stabilized pet dish assembly illustrated in FIG. 8 shown partially broken open to illustrate operation of the fastener assembly;

FIG. 10 is a side view of the stabilized pet dish assembly illustrated in FIG. 8 shown partially broken open to illustrate a further position of the fastener assembly;

FIG. 11 is a side, cutaway view of the stabilized pet dish assembly of the present invention illustrating another preferred embodiment thereof;

FIG. 12 is a side, cutaway view of the stabilized pet dish assembly illustrating another preferred embodiment thereof;

FIG. 13 is an exploded view of a stabilized pet dish assembly according to two additional. alternate preferred embodiments of the present invention;

FIG. 14 is a side view of the stabilized pet dish assembly illustrated in FIG. 13 shown partially broken open;

FIG. 15 is an exploded view of a stabilized pet dish assembly according to two additional, alternate preferred embodiments of the present invention; and

FIG. 16 is a side view of the stabilized pet dish assembly illustrated in FIG. 13 shown partially broken open.

### DESCRIPTION OF THE PREFERRED EMBODIMENT

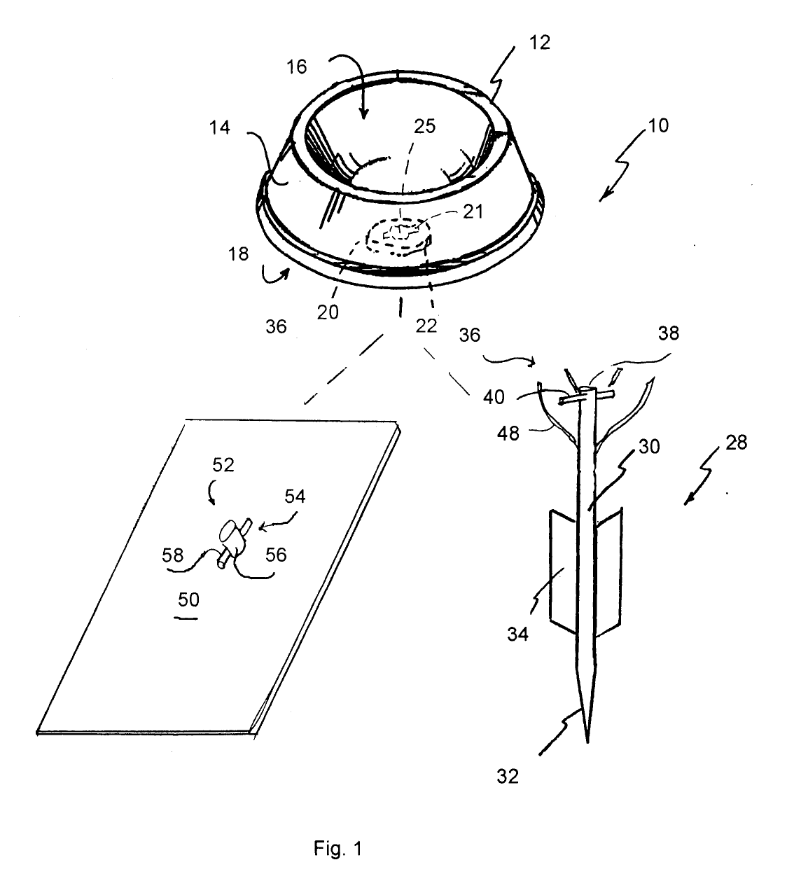

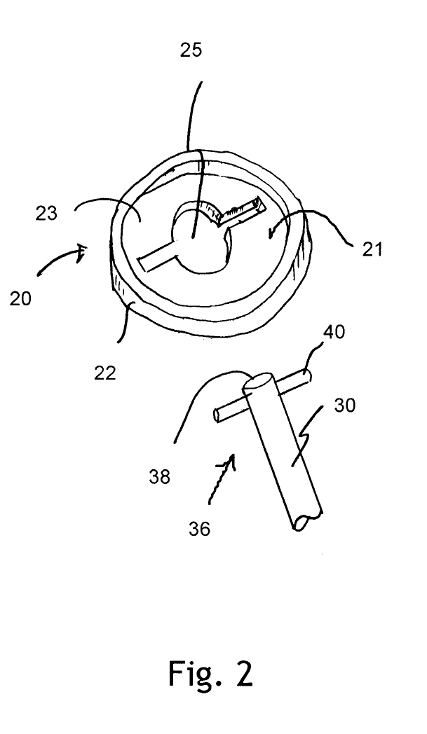

Turning now to the drawings and, more particularly to FIG. 1, a stabilized pet dish assembly is illustrated generally at 10 and includes a dish or vessel 12 having a frusto-conical outer wall curved inwardly to form an inner cavity 16. The dish 12 includes a base portion 18 that is generally circular and planar for ground disposition. It should be noted that the dish 12 can take any number of shapes as long as it defines at least one cavity for receiving pet sustenance items such as water or food therein. Optionally, the dish 12 may be formed with multiple cavities. The dish 12 may be formed of plastic, metal or any other acceptable material. The dish 12 may include a generally planar face portion that extends over substantially the entire surface of the underside of the dish 12 or the dish 12 may be formed from a continuous wall member that is curved and pressed into shape as illustrated in the cutaway view of FIG. 2. Preferably the dish 12 is formed from stainless steel and is pressed into shape.

In order to support and secure the dish 12 in ground engagement, and according to a first option for use outdoors, a support member or stabilizer 28 is provided and is formed as a generally elongate shaft 30 having a generally pointed ground piercing tip 32 at one end thereof and a portion of a fastener assembly fitted to the opposite end, as we explained in greater detail hereinafter. Optionally, a pair of generally planar vanes 34 may project outwardly from the shaft 30 in order to further stabilize the support member 28 when it is inserted in the ground. As it will be appreciated, the vanes 34 will help prevent rotation of the generally cylindrical shaft 30 in the ground when the dish 12 is applied thereto according to the method of the present invention. Optionally, a plurality of upwardly projecting arm members 48 are fitted to the shaft 30 to project upwardly and angularly away therefrom. The arm members 48 terminate at approximately the level of the upper end of the shaft 30 to provide a foot support for the user inserting the support member 28 in the ground using s stepping action. An array of arm members 48 may be disposed at periodic intervals around the shaft 30.

A fastener assembly is provided for mating the dish 12 and the support member 28 in a stabilized manner. With reference to FIG. 2, the fastener assembly includes a first fastener portion 20 including an upstanding circular wall 22 defining a receiving chamber 21 therein for receiving a second fastener portion 36. A keyed cover 23 is provided with a keyway 25 formed therein for receipt of the second fastener portion 36.

With reference to FIG. 1 and FIG. 2, the second fastener portion 38 is formed on one end of the shaft 30 of the support member 28. The second fastener portion 36 includes a body 38 which is formed in a generally cylindrical manner integral with the shaft 30, and is configured for receipt in the receiving chamber 21 of the first fastener portion 20 through the keyway 25. In order to be properly aligned and to lock the dish 12 onto the support member 28, a pair of bosses or tabs 40 extend outwardly from either side of the body 38 of the second fastener portion 36. The bosses 40 are configured for entrance into the receiving chamber 21 through the keyway 25.

Optionally, and with reference to FIG. 1, the dish 12 may be mounted to a mat 50 for use primarily indoors, although the mat 50 may be used outdoors as well with no meaningful loss of effectiveness. A mat-based second fastener portion 52 is mounted to the mat 50 and includes a body 54 including a relatively short, generally cylindrical shaft 56 which is configured for receipt in the receiving chamber 21 of the first fastener portion 20 through the keyway 25. In a manner similar to the first option, and in order to be properly aligned and to lock the dish 12, a pair of bosses or tabs 58 extend outwardly from either side of the body 54. The bosses 58 are configured for entrance into the receiving chamber 21 through the keyway 25. An animal using the dish can stand on the mat, thereby enhancing the stability of the pet dish assembly during use.

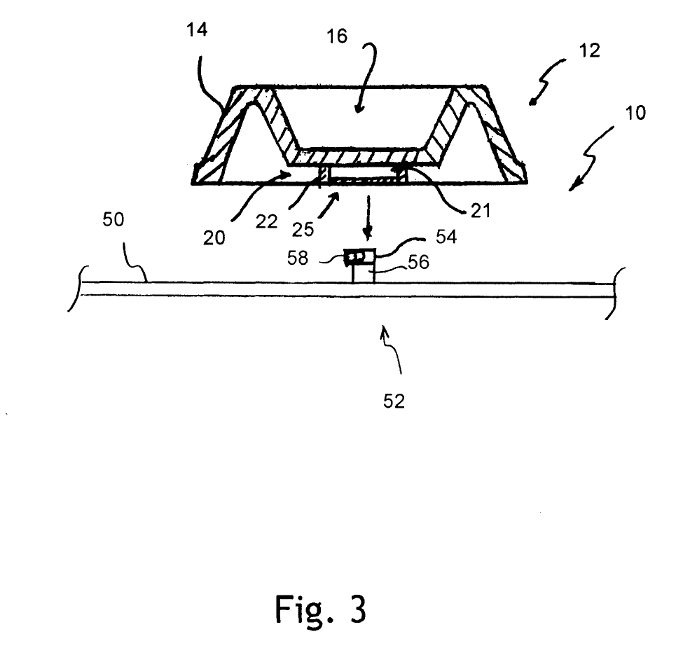

In operation, with reference to FIG. 3 and according to a first embodiment of the method of the present invention, the dish 12 is to be placed onto the mat 50 and locked into position. The mat 50 is either placed at the desired location or otherwise manually manipulated such that the fastener portions 20 and 52 may be operationally engaged. The bosses 58 are directed through the keyway 25 and the dish 12 rotated relative to the mat 50 to lock the dish 12 into place on the mat 50 for indoor or outdoor mat-based usage.

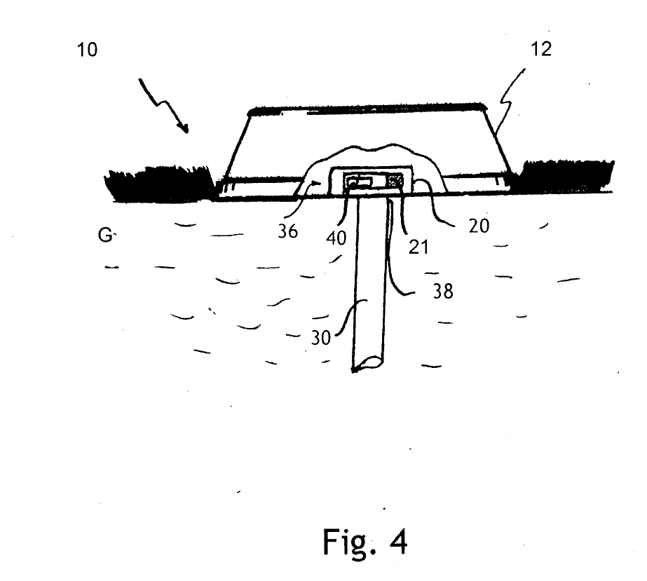

In accordance with a ground-based, outdoor version of the present invention and a second preferred embodiment of the method thereof, and with reference to FIG. 4, the dish 12 is placed onto the support member 28 and locked into position. The support member 28 is driven into the ground G using the ground-penetrating shaft 30 and the tip 32 by pressing on the shaft 30 and the arm members 48, if present. The shaft 30 may be driven into the ground G to a position wherein the second fastener portion 36 projects from the ground G to the minimum extent required for engagement with the dish. Some experimentation may be required to achieve the height relationship, although the dish 12 may be fitted to the shaft 30 at a position above the ground G and then the entire assembly driven toward the ground G. When the dish 12 rests on the ground G, the shaft 30 is a correct depth. The second fastener assembly 36 may be maintained at a height that is below the height of a rotating lawnmower blade so that the support member 28 may remain in the ground G while grooming operations are performed on the surrounding area.

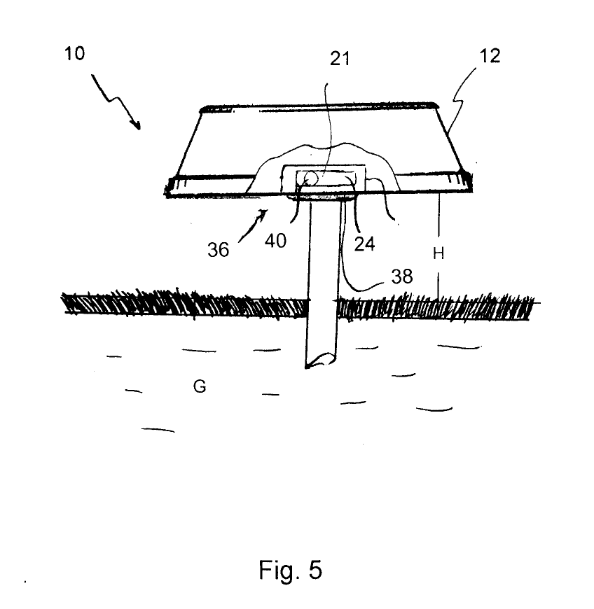

With reference to FIG. 5, the shaft 30 may be inserted to a predetermined depth so as to place the second fastener portion 28, and ultimately the dish 12 at a predetermined height H, e.g. 5 to 7 inches, to accommodate a standing pet.

Once the shaft 30 is in the ground G to the desired depth, and with reference to FIG. 4 and FIG. 5, the dish 12 is placed over the support member 28 in a manner in a manner wherein the bosses 40 extend through the keyway 25 into the receiving chamber 21. As will be seen in greater detail, the dish 12 is then rotated through a predetermined angular displacement which is preferably ¼ turn. It will be understood by those skilled in the art that the term ¼ turn refers to ¼ of a 360 degree rotation. Lesser or greater turn amounts may be incorporated in the present invention without deviating from the spirit and scope thereof. The foregoing description of the ground-based pet dish assembly of the present invention applies to other types of fastener assemblies as will be discussed in greater detail hereinafter. It will be understood by those skilled in the art that operation of the fastener assembly to secure the pet dish to either a mat or a ground-based stake element involves the same operational steps and the foregoing description of mat-based fastener operation applies to ground-based stake element as well.

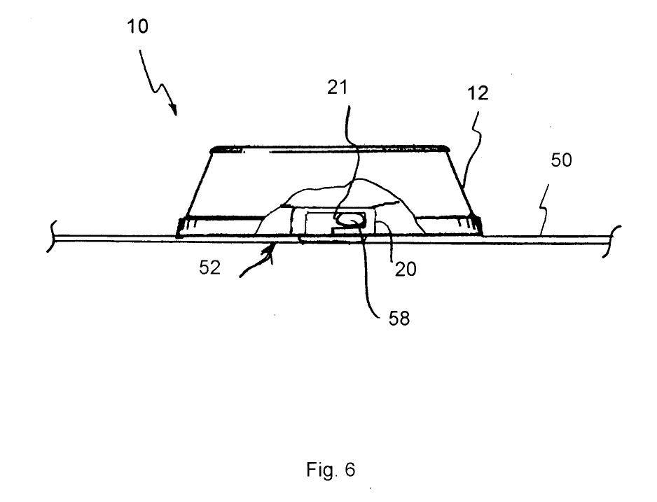

Referring now to FIG. 6, the second fastener portion 52 is affixed to a support mat 50 for engagement with the first fastener portion 20 by moving the bosses 58 into the receiving chamber 21 and rotating the dish 12. The entire pet dish assembly 10 may then be placed on a support surface as desired.

With continued reference to FIG. 6, the dish 12 has been rotated through the predetermined angular displacement and the bosses 58 rotated out of alignment with the keyway 26, thereby locking the first fastener portion 20 and the second fastener portion 52 in a mated relationship and retaining the dish on the mat 50 in a manner that resists removal of the dish 12 without further horizontal rotation in the opposite direction. The dish 12 can therefore be considered locked to the mat 50 and therefore resistant to overturning. With a pet standing on the mat 50, during dish use, the stability of the pet dish assembly 10 is thereby further enhanced.

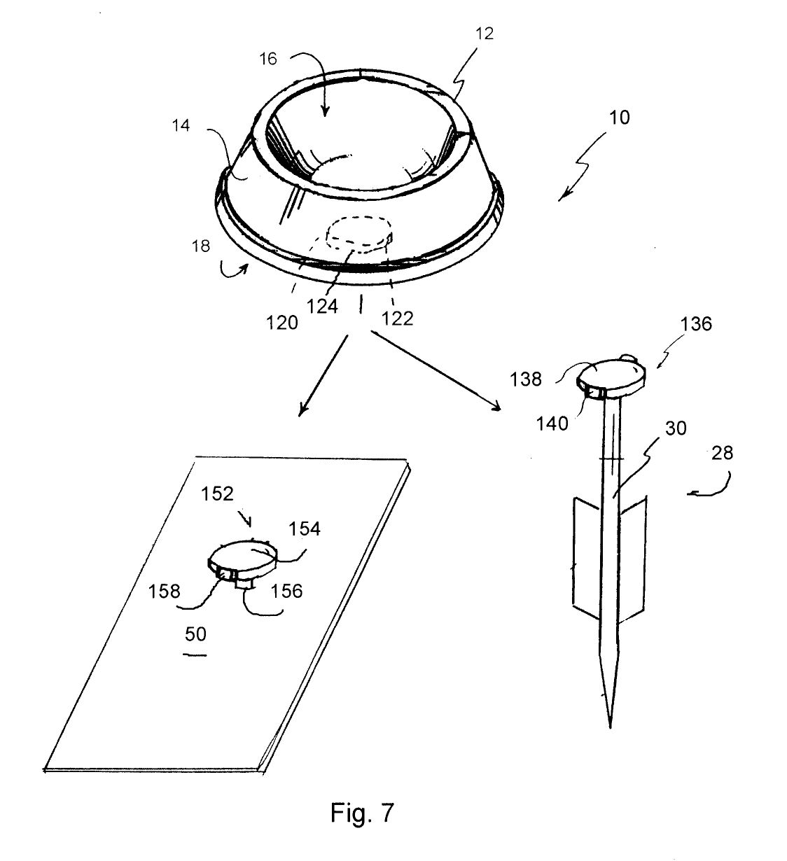

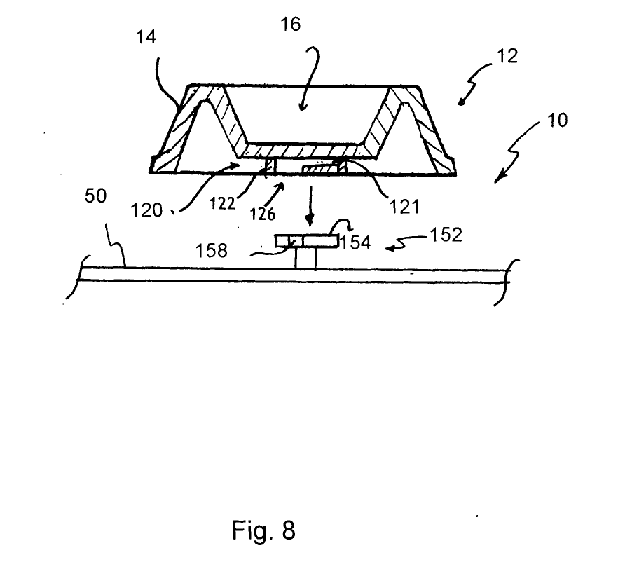

According to another preferred embodiment of the present invention and with reference to FIG. 7 and FIG. 8, another fastener assembly is provided for mating the dish 12 and the support member 28 or mat 50 in a stabilized manner. With continued reference to FIG. 7, the fastener assembly includes a first fastener portion 120 including an upstanding circular wall member 122 defining a receiving chamber therein for receiving a second fastener portion 136, as explained in greater detail hereinafter. The wall member 122 includes a channel 124 formed circumferentially therein. A pair of slots 126 is provided in the wall 122 for entrance to the channel 124, as seen in FIG. 8. A single slot is illustrated in the drawings for clarity.

In a manner similar to the embodiments displayed in FIGS. 1 and 2, and with reference to FIG. 7, the second fastener portion 136 is formed on one end of the shaft 30 of the support member 28. The second fastener portion 136 includes a body 138 which is formed in a generally cylindrical manner and is configured for receipt in the receiving chamber 121 of the first fastener portion 120. In order to be properly aligned and to lock the dish 12 onto the support member 28, a pair of bosses or tabs 140 extend outwardly from either side of the body of the second fastener portion 136. The bosses 140 are configured for entrance into the channel 124 through the slots 126.

Optionally, and with reference to FIG. 7 and FIG. 8, the dish 12 may be mounted to the mat 50 for use primarily indoors, although, as before, the mat 50 may be used outdoors as well with no meaningful loss of effectiveness. A mat-based second fastener portion 152 is mounted to the mat 50 and includes a body 54 including a relatively short, generally cylindrical shaft 56 which is configured for receipt in the receiving chamber 121 of the first fastener portion 120. In a manner similar to the first option, and in order to be properly aligned and to lock the dish 12, a pair of bosses or tabs 158 extend outwardly from either side of the body 154. The bosses 158 are configured for entrance into the receiving chamber 121. Slots 126 are formed in the wall 122 to receive the bosses 158 from the second fastener portion for travel within the channel 124.

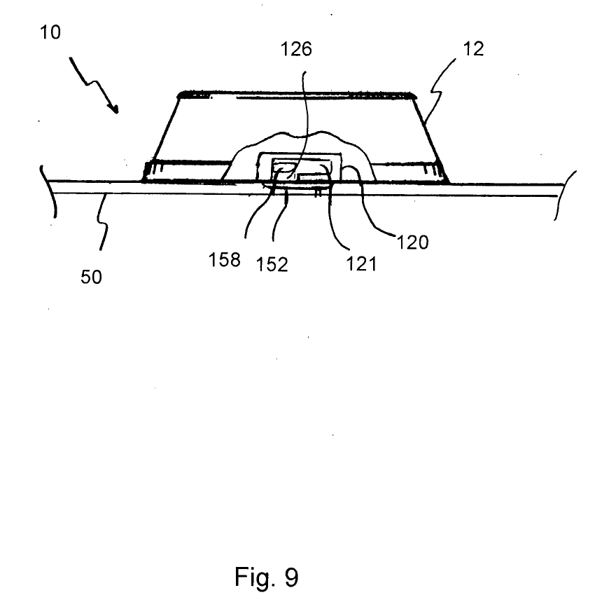

In operation and according to another preferred embodiment of the method of the present invention, the dish 12 is placed onto the mat-based support member 152 and locked into position. Referring now to FIG. 8 and FIG. 9, the second fastener portion 152 is affixed to a support mat 50 for engagement with the first fastener portion 120 by moving the bosses 158 into the receiving chamber 121 using the slot 126 and then rotating the dish 12. The entire pet dish assembly 10 may then be placed on a support surface as desired. An animal using the dish can stand on the mat, thereby enhancing the stability of the pet dish assembly during use.

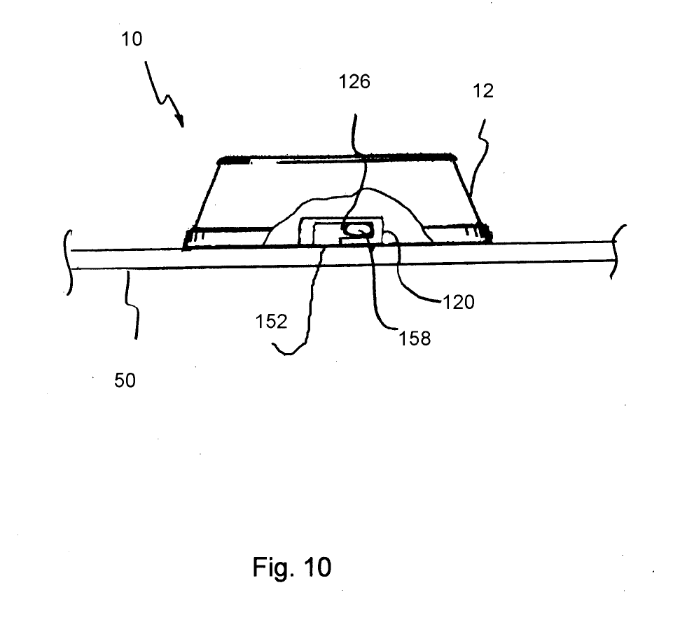

With reference to FIG. 10, the dish 12 has been rotated through the predetermined angular displacement and the bosses 158 have traveled along the channel 124 out of alignment with the slots 126, thereby locking the first fastener portion 120 and the second fastener portion 152 in a mated relationship and retaining the dish on the mat 50 in a manner that resists removal of the dish 12 without further horizontal rotation in the opposite direction.

The dish 12 may be rotated through a predetermined angular displacement which is preferably between ¼ turn and ½ turn. It will be understood by those skilled in the art that the terms ¼ turn and ½ turn refer to ¼ of a 360 degree rotation and ½ of a 360 degree rotation, respectively. Lesser or greater turn amounts may be incorporated in the present invention without deviating from the spirit and scope thereof. The dish 12 can therefore be considered locked to the mat 50 and therefore resistant to overturning. With a pet standing on the mat during dish use, the stability of the pet dish assembly 10 is thereby enhanced.

It will be understood that using the version of the pet dish assembly that includes a ground-engaging shaft 30, once the shaft 30 is in the ground G, the dish 12 is placed over the support member 28 in a manner wherein the bosses 140 extend into the entrances 126 to the receiving chamber 121. The dish 12 is then rotated through a predetermined angular displacement which is preferably between ¼ turn and ½ turn. It will be understood by those skilled in the art that the terms ¼ turn and ¼ turn refer to ¼ of a 360 degree rotation and ½ of a 360 degree rotation, respectively. Lesser or greater turn amounts may be incorporated in the present invention without deviating from the spirit and scope thereof. When the dish 12 has been rotated through the predetermined amount and the bosses 140 are engaged fully with the slot 124, thereby locking the first fastener portion 120 and the second fastener portion 136 in a mated relationship and retaining the dish on the ground G in a manner that resists removal of the dish 12 without further horizontal rotation in the opposite direction. The dish 12 can therefore be considered locked to the ground G and therefore resistant to overturning.

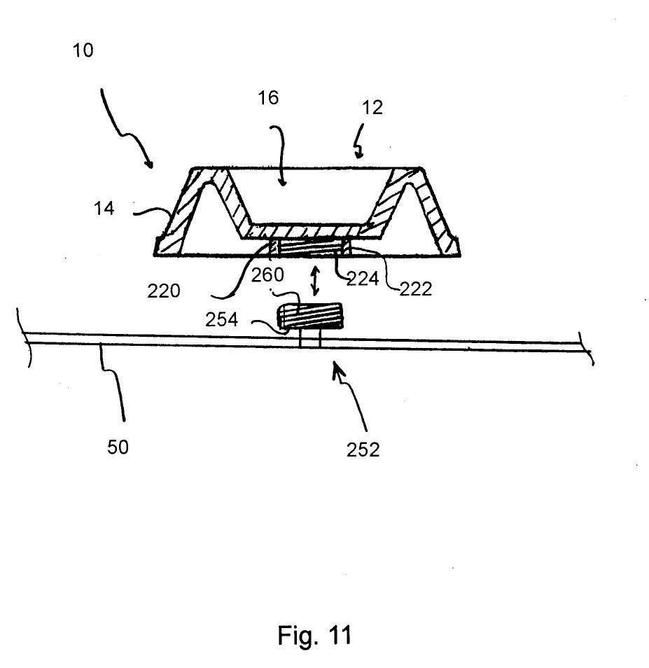

Another preferred embodiment of the present invention eliminates both the foregoing bayonet connectors by using screw threads. As seen in FIG. 11, the walls 222 of the first fastener portion 220 are formed with screw threads 224 on an internal portion thereof. Corresponding threads 260 are formed on the body 254 of the second fastener portion 252.

In operation, the dish 12 is placed on the mat 50 with the second fastener portion 252 threadedly engaged with the first fastener portion 220 such that the threads 260 on the second fastener portion 252 operationally engage the threads 224 on the first fastener portion 220. Rotation of the dish 12 through multiple forward rotations is required for complete engagement of the dish 12 with the mat 50.

It will be understood that the threaded connector is a ready substitute for the bayonet type connectors when attached to a shaft for ground engagement in the outdoor-only version of the pet dish assembly.

The threaded connector assembly can provide a more secure connection over the bayonet types discussed previously. Nevertheless, the screw thread type takes more time and effort for engagement. With respect to the shaft-based outdoor-only version, one advantage of the threaded-type connector is that the length of the body portion 38 may be varied such that the depth of penetration of the shaft 30 is more variable than with the bayonet-type connector. It should be noted however, that the threaded body portion 38 should not project beyond the level at which it would engage a mower blade during grooming operations of the surrounding area.

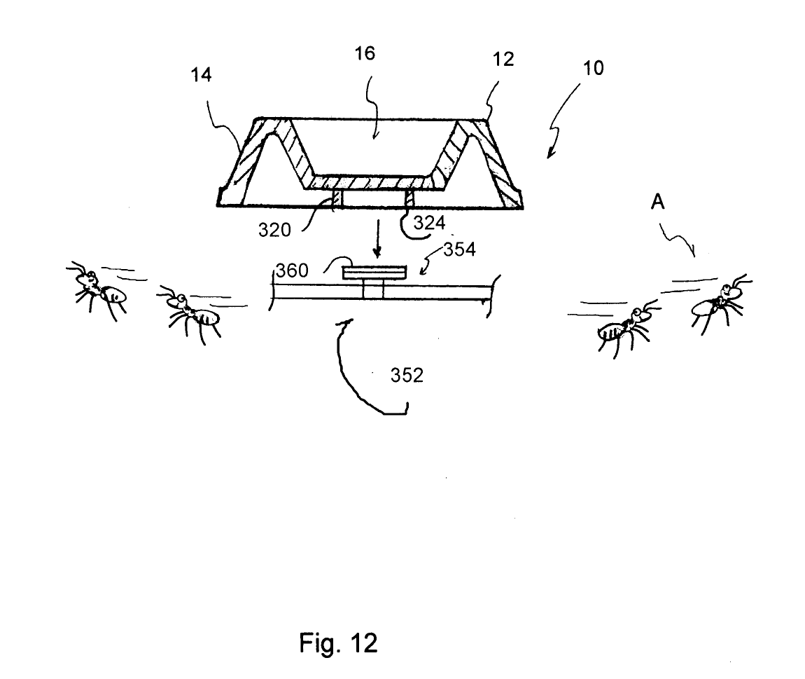

According to another preferred embodiment of the present invention, and with reference to FIG. 12, a magnet 360 is attached to the second fastener portion 352 and projects upwardly from the body portion 354 thereof. As before, the body portion 354 of the second fastener portion 352 is configured for fitment within the wall 324 defining the receiving chamber of the first fastener portion 320. A magnetically attractive element (not shown) may be mounted within the first fastener portion 320 or the walls 14 forming the dish 12 may be formed from a magnetically attractive metallic material. Alternately, the magnet may be attached to the dish 12 and the magnetically attractive element may be mounted to the second fastener portion 352 or the second fastener portion 352 may be formed from a magnetically attractive metallic material.

It will be apparent that the magnetic connector can provide a ready substitute for the other heretofore discussed connectors on a shaft-based outdoor version of the pet dish assembly of the present invention.

In operation, the dish 12 is placed onto the mat 50 such that the body 354 and magnet 360 of the second fastener portion 352 is received by the first fastener portion 320 and the magnetic attraction between either the walls 14 of the dish 12 or the magnetically attractive element (not shown) retains the dish in place on the ground G. An advantage of this embodiment is that no rotation of the dish 12 is required for mating with the support member. Therefore, placing the dish assembly in a stabilized manner can occur more rapidly than with the bayonet connector version or the threaded version of the present invention.

Use of the magnetic fastener assembly provides an additional advantage. The magnet can act to repel ants. For their sense of direction, ants use magnetic fields, such as the weak magnetic fields generated by the electrical wiring in buildings, which are substantially constant. By using the magnetic fastener assembly, the magnetic fields are altered, which makes ants flee in an attempt to reorient themselves. Therefore, the pet dish assembly with a magnetic fastener assembly tends to repel ants A as shown in FIG. 12.

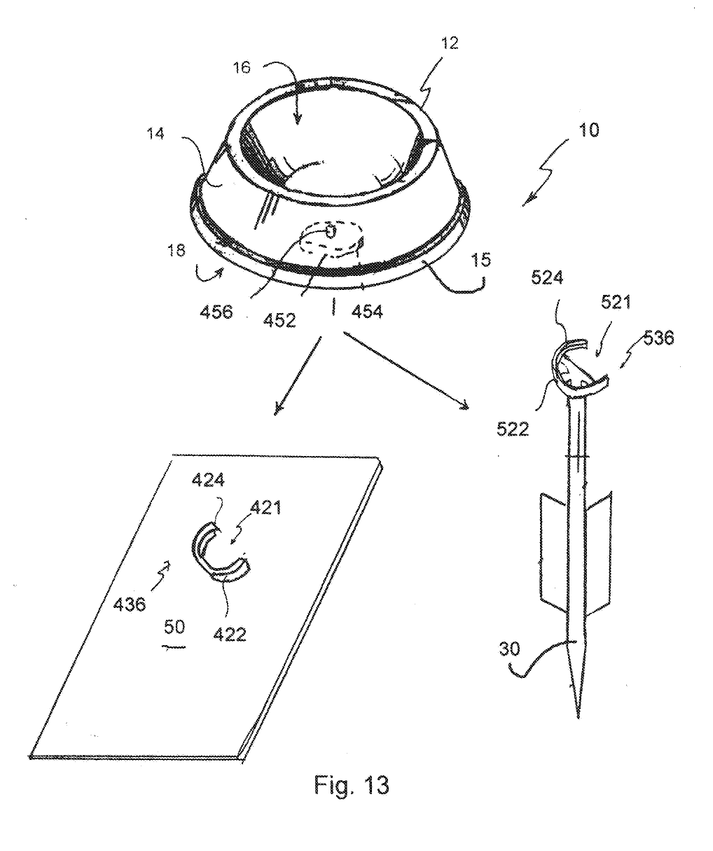

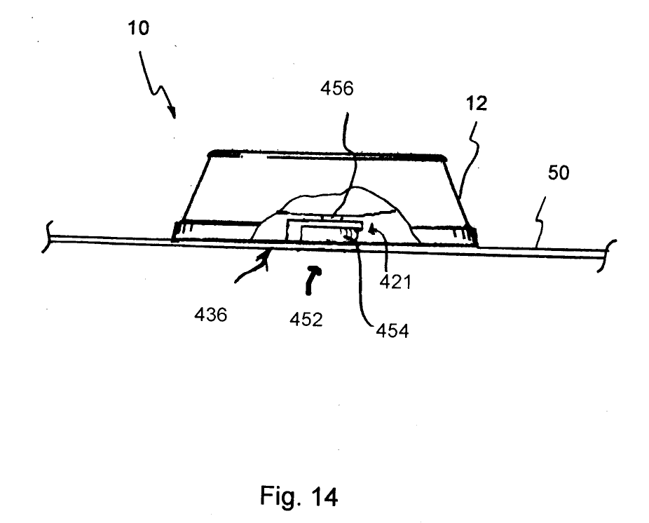

Another preferred embodiment of the present invention is illustrated in FIG. 13 and FIG. 14. With reference thereto, another preferred embodiment of the present invention is illustrated and includes another different structure for the fastener portions. In FIG. 13, a first fastener portion 452 includes a disc element 454 suspended a predetermined spacing from the bottom portion of the dish wall 12 by a short stem 456. A second fastener portion forms a carriage element 436 attached to the mat 50 and includes a semicircular element forming a receiving cavity 421. The semicircular element is formed to extend in an approximately 180 degree arch by an upstanding wall portion 422 and a flange 424 mounted to the wall portion 422 and projecting radially inwardly therefrom in a generally perpendicular relationship with the wall portion 422 thereby forming the receiving chamber 421 for the disc 454.

A similar structure may be mounted to a stake for outdoor use. As seen in FIG. 13, the stake version of the carriage element 536 includes an upstanding wall portion 522 with a flange 524 mounted to an upper portion thereof and projecting radially inwardly to define a receiving chamber 521. The second fastener portion 536 is mounted to a stake 30 for penetrating ground use.

As seen in FIG. 14, and in operation, the disc 454 may slide inwardly into the receiving chamber 421 for retention by the wall 422 and the flange 424 to hold the dish body 12 to the mat 50. The outdoor version of the present invention operates in a matter similar to the mat version with the disc 454 being received by the receiving chamber 521 and held in place by contact with the wall 522 and the flange 524. It will be apparent to those skilled in the art that the fastener portions 432, 436, 536 illustrated in FIG. 13 and FIG. 14 are interchangeable such that the carriage element 436, 536 may be fitted to the dish body 12 and the disc 454 fitted to either the mat 50 or the stake 30. Operation is essentially the same with the disc 454 being confined in the receiving chambers, 421, 521 and it will be understood that a single receiving chamber may be mounted to the dish body 12 with a disc 454 mounted to each of the mat 50 and the stake 30.

It should also be understood that the dish body 12 may be formed with a radially projecting lip or flange 15 for contact with the mat or ground. In that case, the mat may be formed with a wall 422 having a radius slightly larger than the dish body 12 for receipt of the dog dish flange 15 to lock the body 12 into place on the mat 50. This could also be accomplished with a stake based version although the larger receiving chamber is best suited for a mat use.

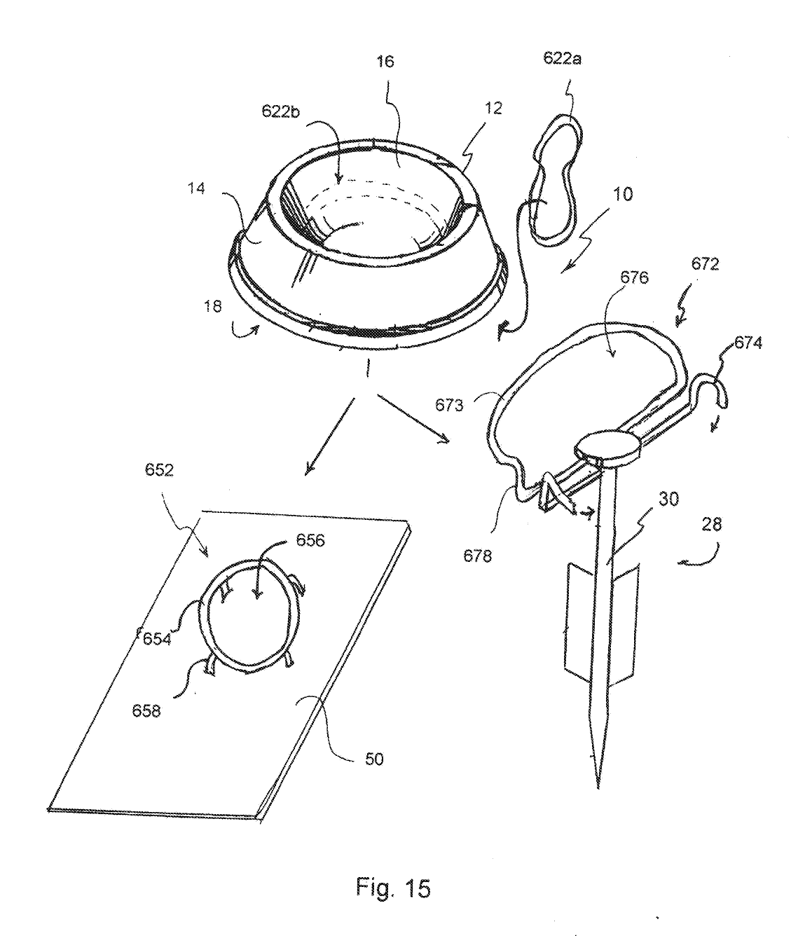

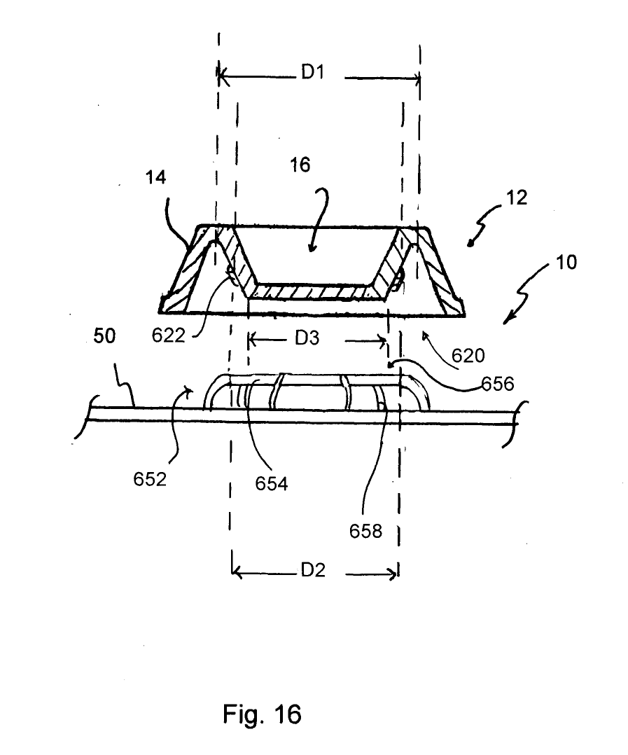

Another preferred embodiment of the present invention is illustrated in FIG. 15 and FIG. 16. With reference thereto, another preferred embodiment of the present invention is illustrated and includes another the fastener assembly. In FIG. 16, the first fastener portion is illustrated at 622. With reference to FIG. 15 and FIG. 16, the first fastener portion may be formed as a elastic flexible band illustrated at 622A for positioning on the walls 16 of the pet dish 12 as illustrated in the phantom at 622B. The first fastener portion may also be represented by the inner wall of the sloping dish as seen in FIG. 16. The band 622 is snug at a portion of the sloping wall 16 of the dish 12 and extends around a diameter illustrated at D2. The diameter D2 lies intermediate to the diameter of the upper portion of the dish illustrated at D1 and the diameter of the lower portion of the dish illustrated at D3 with the sloping wall sloping inwardly from diameter D1 to diameter D3. The portion at diameter D2 is the contact area for the dish body 12 and the ring 654 mounted to the mat 50 as seen in FIG. 16 It will become apparent that the elastic band 622 is not necessarily required but is favored for enhanced operation.

For use with a mat 50, the second fastener portion is illustrated at 652 and includes a substantially circular continuous loop forming a ring 654 defining an aperture 656 that is supported a predetermined distance above the mat 50 by a plurality of legs 658. Optionally, a traction surface may be formed on the ring 654. Although four legs 658 are illustrated, there is no requirement that the number of legs must be four.

A similar structure provides the necessary aperture for use with a stake 30 in an outdoor ground engagement situation. With continued reference to FIG. 15, the aperture 676 is defined by two semicircular ring portions 673, 674, each made from a rod extending away from the stake 30 and is curved upwardly to form a leg 678. The rod then curves outwardly to form a rim 673 that defines a semicircle aperture. A mirror structure illustrated at 674 provides the second half of the ring structure, and thereby a generally circular aperture 676 for receiving and retaining the first fastener portion 620 of the pet dish. Optionally, a traction surface may be formed on the ring 673,674.

In operation, the band 622 may be placed on the dish body 12. The band 622 may also not be present in any shape or form although a rubber surface can provide an enhanced traction surface to further enhance the stability of a dish within the ring 654. With or without the band 622, the pet dish is placed over the second fastener portion 652 with the first fastener portion 622 in frictional contact with the ring 654 inner diameter. The inner diameter of the ring 654 conforms to diameter D2 at the contact surface of the frusto-conical wall defining the bowl portion of the pet dish 12. The stability of the dish is thereby enhanced. Using the outdoor version, the stake 30 is driven into the ground with the ring 673, 674 spaced above the ground sufficiently to accommodate the pet dish 12 in a manner similar to the mat-based structure.

By the above, the present invention provides a stabilized pet dish for indoor and outdoor use that can function essentially as a conventional pet dish in that it can be removed from the support and used without a mat or a shaft for ground insertion, cleaned or refilled and returned to the outdoor position and locked into place on the mat or ground without movement of the support member which remains in the ground throughout. There should be no reason to remove the support mat or member from the ground and therefore, the present stabilized pet dish provides ease of use that has been heretofore unobtainable with past stabilized pet dishes.

It will therefore be readily understood by those persons skilled in the art that the present invention is susceptible of a broad utility and application. While the present invention is described in all currently foreseeable embodiments, there may be other, unforeseeable embodiments and adaptations of the present invention, as well as variations, modifications and equivalent arrangements, that do not depart from the substance or scope of the present invention. The foregoing disclosure is not intended or to be construed to limit the present invention or otherwise to exclude such other embodiments, adaptations, variations, modifications and equivalent arrangements, the present invention being limited only by the claims appended hereto and the equivalents thereof.

I claim:

1. A vessel assembly for holding and presenting solids, liquids or both, the vessel assembly comprising:
a vessel body having a base portion and at least one wall member extending from the base portion and defining at least one cavity for containing solids, liquids or both;
a stabilizer element including a stabilizer body for engagement with an underlying surface; and
a fastener assembly for releasably retaining the body and the stabilizer in a mated relationship, the fastener including a first fastener portion operatively associated with the vessel body and a second fastener portion operatively associated the stabilizer in a configuration for mating with the first fastener portion when the second fastener portion for stabilizing the vessel.

2. A vessel assembly according to claim 1 wherein the stabilizer body is formed as a generally planar mat having the fastener assembly disposed thereonto.

3. A vessel assembly according to claim 2 wherein the mat extends in a generally horizontal manner outwardly from the vessel body.

4. A vessel assembly according to claim 1 wherein the mat is configured for displaying indicia thereon.

5. A vessel assembly according to claim 1 wherein at least one of the first fastener portion and the second fastener portion includes a receiving chamber formed therein and the other of the at least one first fastener portion and second fastener portion includes a body portion configured for receipt in the receiving chamber, with the receiving chamber configured for selective retention of the body portion in a mated relationship therewith.

6. A vessel assembly according to claim 1 wherein the first fastener portion and the second faster portion are configured for engagement with one another by relative rotational motion of the first fastener portion and the second fastener portion between a first position wherein the first fastener portion is engaged with the second fastener portion and a second position wherein the first fastener portion and the second fastener portion are retained in a mated relationship, thereby retaining the vessel and the stabilizer in a mated relationship.

7. A vessel assembly according to claim 1 wherein at least one of the first fastener portion and the second fastener portion includes at least one wall forming a receiving chamber therein, with the at least one wall being threaded and the other of the at least one first fastener portion and the second fastener portion includes a fastener body being formed with threads operationally corresponding to the threads formed on the receiving chamber, with the receiving chamber being configured for selective retention of the fastener body in a threadedly mated relationship therewith.

8. A vessel assembly according to claim 1 wherein at least one of the first fastener portion and the second fastener portion is formed with a receiving portion and the other of the at least one first fastener portion and second fastener portion includes a corresponding member configured for receipt by the receiving portion, with at least one magnet being disposed on at least one of the receiving portion and the corresponding member, and wherein at least one of the receiving portion and the corresponding member includes a magnetically attractive element for selective retention of the receiving portion in a magnetically mated relationship with the corresponding member.

9. A pet dish assembly for holding and presenting pet-related items the pet dish comprising;
a dish body having a base portion and at least one wall member extending from the base portion and defining at least one cavity for containing pet related items;
a support member including a generally elongate body for engagement with an underlying surface; and
a fastener assembly for releasably retaining the dish and the support member in a mated relationship, the fastener including a first fastener portion operatively associated with the dish and a second fastener portion operatively associated with the support member in a configuration for mating with the first fastener portion for impeding relative movement of the dish body and the support member when the pet dish assembly is in use.

10. A pet dish assembly according to claim 9 wherein the support member includes a generally planar horizontally extending mat for generally parallel engagement with a support surface.

11. A pet dish assembly according to claim 10 wherein the mat is configured for displaying indicia thereon

12. A pet dish assembly according to claim 9 wherein the support member includes a generally elongate body for penetrating ground engagement

13. A pet dish according to claim 9 wherein at least one of the first fastener portion and the second fastener portion is formed with at least one wall defining the receiving chamber, with the at least one wall being formed with at least one slot therein and the other of the first fastener portion and the second fastener portion includes at least one boss projecting therefrom and configured for selective engagement with the at least one slot for selective retention of the vessel and the stabilizer in a mated relationship.

14. A pet dish according to claim 13 wherein the first fastener portion and the second faster portion are configured for engagement with one another by relative rotational motion of the first fastener portion and the second fastener portion between a first position wherein the first fastener portion is engaged with the second fastener portion and a second position wherein the first fastener portion and the second fastener portion are retained in a mated relationship, wherein the vessel and the stabilizer are retained in a mated relationship.

15. A pet dish according to claim 9 wherein at least one of the first fastener portion and the second fastener portion includes at least one wall forming a receiving chamber therein, with the at least one wall being threaded and the other of the at least one first fastener portion and the second fastener portion includes a fastener body being formed with threads operationally corresponding to the threads formed on the receiving chamber, with the receiving chamber being configured for selective retention of the fastener body in a threadedly mated relationship therewith.

16. A pet dish according to claim 9 wherein at least one of the first fastener portion and the second fastener portion is formed with a receiving portion and the other of the at least one first fastener portion and second fastener portion includes a corresponding member configured for receipt by the receiving portion, with at least one magnet being disposed on at least one of the receiving portion and the corresponding member, and wherein at least one of the receiving portion and the corresponding member includes a magnetic element for selective retention of the receiving portion in a magnetically mated relationship with the corresponding member, the magnetic element acting to generally repel ants.

18. A method for stabilizing a pet dish assembly for holding and presenting pet-related items, the method comprising the steps of:
providing a pet dish including a dish body having a base portion and at least one wall member extending from the base portion and defining at least one cavity for containing pet related items;
providing a support member including a generally elongate body for engagement with an underlying surface;
providing a fastener assembly including a first fastener portion operatively associated with the dish and a second fastener portion operatively associated with the support member in a configuration for mating with the first fastener portion;
engaging the support member with the underlying support surface; and
placing the pet dish on the support member in a manner wherein the first fastener portion and the second fastener portion are in a mated relationship.

19. A method for stabilizing a pet dish according to claim 18 wherein:
the step of providing a support member including a generally elongate body for engagement with an underlying surface, includes providing a generally planar mat for carrying at least one of the first fastener element and the second fastener element, and the step of engaging the support member with the underlying support surface includes placing the mat on a generally horizontal support surface with the mat extending generally horizontally from the pet dish when in use, wherein a pet can stand on the mat with the dish stabilized thereon to further enhance the stability of the pet dish assembly.

20. A method for stabilizing a pet dish according to claim 18 wherein:
the step of providing a fastener assembly includes providing a fastener assembly wherein at least one of the first fastener portion and the second fastener portion is formed with at least one wall defining a receiving chamber, with the at least one wall being formed with at least one slot therein and the other of the first fastener portion and the second fastener portion having at least one boss projecting therefrom and configured for selective engagement with the at least one slot for selective retention of the dish and the support member in a mated relationship; and
the step of providing a support member includes providing a ground piercing elongate member for ground engagement;
the set of engaging the support member with the underlying support surface includes piercing the ground with the support member to a predetermined depth wherein the fastener element is disposed at a predetermined vertical spacing with the ground surface to elevate the pet dish body to a predetermine height above the ground surface; and
the step of placing the pet dish on the support member in a manner wherein the first fastener portion and the second fastener portion are in a mated relationship includes engaging the at least one boss projecting from the body portion with the at least one slot formed in the at least one wall of the first fastener portion for selective retention of the dish and the support member in a mated relationship, wherein the pet dish body is disposed at the predetermine height above the ground surface.
